(19) United States
(12) Patent Application Publication
(10) Pub. No.: US 2018/0065424 A1
(43) Pub. Date: Mar. 8, 2018

(54) BEAD-APEX ASSEMBLY FOR A VEHICLE TIRE

(71) Applicant: Bartell Machinery Systems, L.L.C., Rome, NY (US)

(72) Inventors: John R. Russo, II, Marcy, NY (US); Kevin Richard Razy, Lee Center, NY (US); Paul David Gatley, Holland Patent, NY (US)

(73) Assignee: Bartell Machinery Systems, L.L.C., Rome, NY (US)

(21) Appl. No.: 15/692,052

(22) Filed: Aug. 31, 2017

Related U.S. Application Data
(60) Provisional application No. 62/384,561, filed on Sep. 7, 2016.

(51) Int. Cl. B60C 15/06; B60C 15/05

(52) U.S. Cl. CPC B60C 15/0607; B60C 2015/044; B60C 2015/061; B60C 15/05

(57) ABSTRACT

In one general aspect, the present disclosure provides a bead-apex assembly for a vehicle tire. The bead-apex assembly may include a bead with an outer diameter surface, and an apex with a first layer and a second layer, the first layer having an inner diameter located adjacent to the outer diameter surface of the bead, and the second layer having an inner diameter located adjacent to an outer diameter of the first layer.

### CROSS-REFERENCE TO RELATED APPLICATIONS

This application claims priority to U.S. Provisional Patent Application Ser. No. 62/384,561, filed Sep. 7, 2016, which is incorporated by reference herein in its entirety.

### BACKGROUND

A vehicle tire generally has two annular bead rings (herein referred to as “beads”) at the innermost diameter, which provides a vehicle tire with hoop strength and structural integrity. The beads also provide stiffness at the point where the tire mounts to a rim. Beads are generally manufactured by winding metal wire in a groove on the outer periphery of a chuck or drum. Existing equipment is capable of forming a plurality of beads on the outer periphery of a single chuck or drum at once. For example, beads may be formed on equipment incorporating components from commercially available products such as the SWS-6000 bead Winding System or the SWS-4000T Bead Winding System, each of which is manufactured by Bartell Machinery Systems, L.L.C. of Rome, N.Y.

The bead is often attached to a strip made of rubber or another synthetic material. This strip is generally called an apex or filler. The apex or filler generally is applied to the outer periphery of the bead and provides a smooth transitional juncture between each bead and the adjacent side wall of the vehicle tire. An apex is generally applied to a bead through the use of automatic rubber extrusion and profiling equipment and equipment for wrapping the apex or filler around the bead and seaming the two free ends of the strip together. The apex is typically formed as a single extruded strip and wound around the outer diameter surface of the bead in a single pass.

### BRIEF SUMMARY

In one general aspect, the present disclosure provides a bead-apex assembly for a vehicle tire. The bead-apex assembly may include a bead with an outer diameter surface, and an apex with a first layer and a second layer, the first layer having an inner diameter located adjacent to the outer diameter surface of the bead, and the second layer having an inner diameter located adjacent to an outer diameter of the first layer.

In some embodiments, the first layer may include a first apex section and a second apex section, where each of the first apex section and the second apex section are adjacent to the outer diameter surface of the bead. The first apex section may include a core formed of a first material and a sheath formed of a second material. The first apex section and the second apex section may be formed by a continuous strip. The first layer may be at least partially formed of a first strip, where the second layer is at least partially formed of a second strip, and where the first strip is separate from the second strip. The first layer may have a width larger than a width of the second layer. The first layer may have a first length, where the second layer has a second length, and where the second length is greater than the first length. The first layer may include a first rigidity, where the second layer includes a second rigidity, and where the first rigidity is greater than the second rigidity.

Another general aspect of the present disclosure provides a bead-apex assembly for a vehicle tire, including a bead with an outer diameter surface, and an apex with a first apex section and a second apex section. The first apex section may be attached to the outer diameter surface of the bead, and the first apex section may be placed at least partially between the outer diameter surface of the bead and the second apex section.

In some embodiments, a third apex section may be included, where the third apex section is located adjacent to the first apex section, and where the third apex section is located adjacent the outer diameter surface of the bead. The first apex section and the third apex section may form at least a portion of a first layer, and the second apex section may form at least a portion of a second layer, the first layer being located at least partially between the second layer and the outer diameter surface of the bead. The first apex section and the third apex section may be formed by a continuous strip. The first apex section may be formed when wrapped around the outer diameter surface of the bead during a first pass, and the third apex section may be formed when wrapped around the outer diameter surface of the bead during a second pass. The first apex section and the second apex section may each include a core formed of a first material and a sheath formed of a second material. The first apex section may include a first material, where the second apex section includes a second material, and where the first material is different than the second material. The first apex section and the second apex section may each have a circular cross-sectional profile. The first apex section may have a first length, where the second apex section has a second length, and where the first length is greater than the second length.

In another general aspect of the present disclosure, a method for forming a bead-apex assembly is provided. The method may include wrapping a first apex section around an outer diameter surface of a bead and wrapping a second apex section around the outer diameter surface of the bead after the step of wrapping the first apex section around the outer diameter surface of the bead. The first apex section and the second apex section may be formed by a continuous strip.

In some embodiments, the method may further include wrapping a third apex section around an outer diameter surface of the first apex section such that the first apex section is located at least partially between the outer diameter surface of the bead and the third apex section. The first and second apex sections may at least partially form first layer adjacent to the outer diameter surface of the bead, and the method may further include forming a second layer located radially outward of the second layer.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designated corresponding parts throughout the different views.

FIG. 1 shows a side cross-sectional view of a tire with a bead-apex assembly.

FIG. 2 shows a side cross-sectional view of the bead-apex assembly of FIG. 1.

FIG. 3 shows a side cross-sectional view of an embodiment of a bead-apex assembly with multiple layers in accordance with the present disclosure.

FIG. 4 shows a side cross-sectional view of an embodiment of a bead-apex assembly having multiple apex sections and multiple layers in accordance with the present disclosure.

FIG. 5 shows a side cross-sectional view of an embodiment of a bead-apex assembly having multiple apex sections and multiple layers in accordance with the present disclosure.

### DETAILED DESCRIPTION

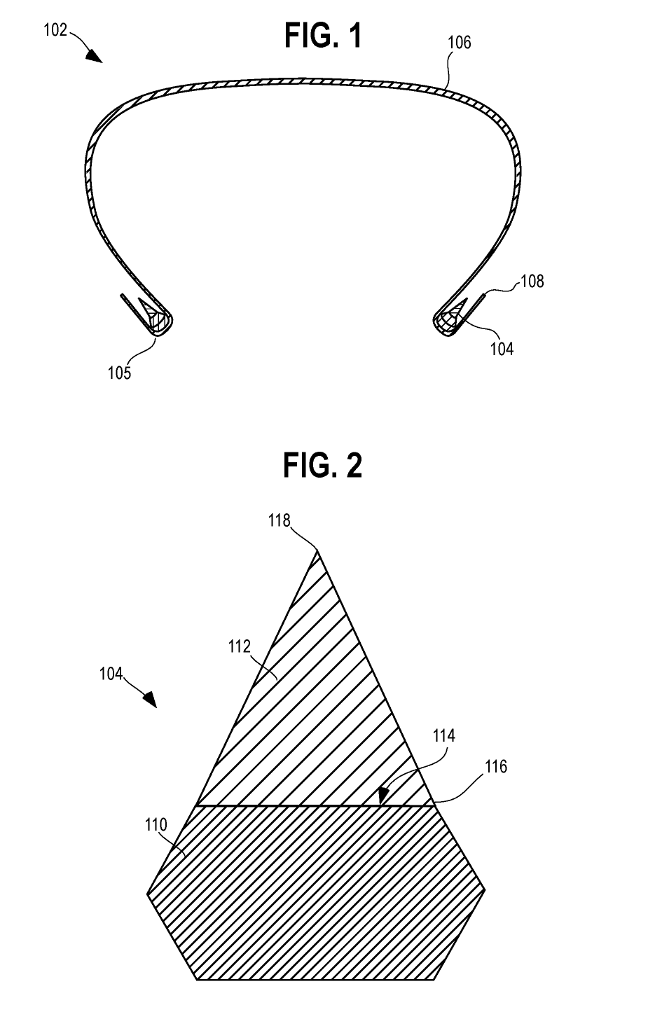

The present embodiments generally relate to a bead-apex assembly for a vehicle tire. Referring to FIG. 1, a tire 102 may include a pair of bead-apex assemblies 104 at or near an inner diameter 105. As shown, each of the bead-apex assemblies 104 may be located adjacent to an annular ply 106, where the ply 106 includes a folded portion 108 such that the bead-apex assembly 104 is at least partially wrapped within the ply 106. Other components of the tire 102, such as the tread, optional inner liners, belts, etc. are not shown in FIG. 1. The bead-apex assembly 104 may be configured to provide the tire with hoop strength, structural integrity, and may provide stiffness at the point where the tire 102 mounts to a rim.

FIG. 2 shows a close-up side cross-sectional view of a portion of the bead-apex assembly 104 of FIG. 1. The bead-apex assembly 104 may include a bead 110 and an apex 112. The apex 112 may be attached to, and adjacent to, an outer diameter surface 114 of the bead 110 and may extend radially-outward from the bead 110. The bead 110 may be made of a relatively rigid material such as a metal, and the apex 112 may be made of a relatively flexible and compliant material such as rubber or another suitable synthetic material. The apex 112 may be formed and attached to the bead 110 to form the bead-apex assembly 104 through any suitable means, for example with the use of an Automatic Truck Bead Apex System manufactured by Bartell Machinery Systems, L.L.C.

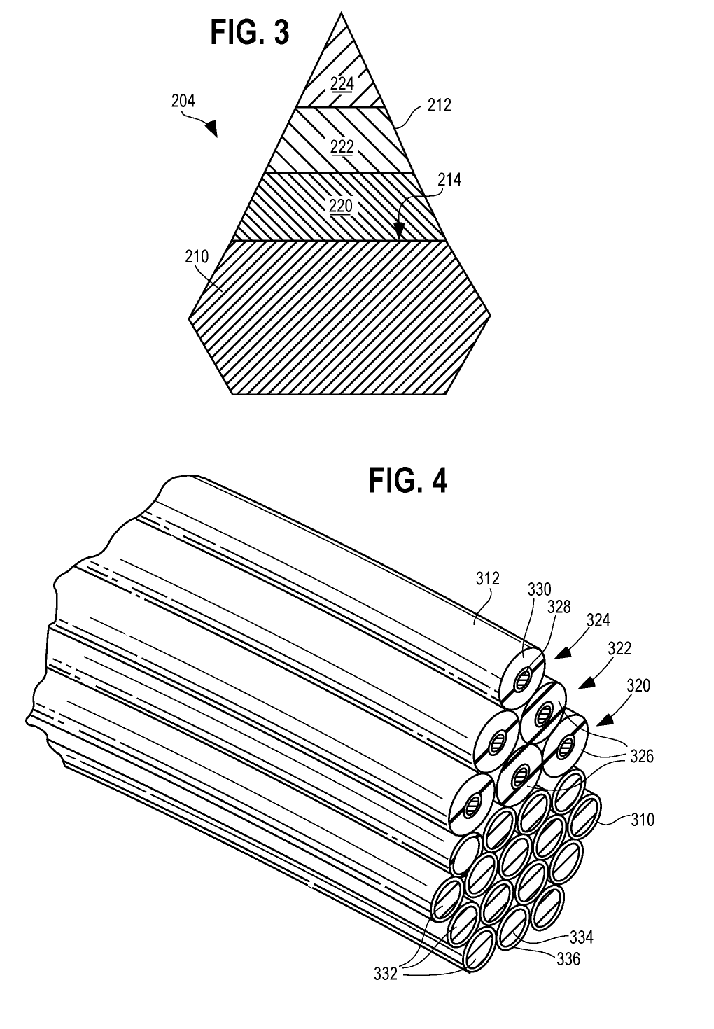

As shown, the apex 112 may be triangular in cross-sectional shape or otherwise have a cross-sectional profile that decreases in width as it extends radially outward from the bead 110. This may be advantageous for providing a gradual transition between the bead 110 and the adjacent side walls of the folded ply 106 (see FIG. 1). The apex 112 may be formed during an extruding process which may include extruding an elongated strip of material having the cross-section of the apex 112 and then wrapping the strip around the formed annular bead 110 in one pass. Once the apex 112 is wrapped around the annular bead 110, the circumference of an inner diameter 116 of the apex 112 will necessarily be less than the circumference of an outer diameter 118. Accordingly, if the apex 112 is extruded as a straight single strip of material, the material at the outer diameter 118 of the apex 112 may be subjected to a tension that is greater than a tension of the inner diameter 116. The difference in tension between the inner diameter 116 and the outer diameter 118 may cause the material of the apex 112 at or near the outer diameter 118 to stretch, warp, crack, break, or otherwise have a tendency to not be uniform. The lack of uniformity may, for example, cause the bead-apex assembly 104 (and its associated tire) to be out of balance during testing and/or when it reaches the consumer. Thus, to overcome this issue, it may be desirable to provide an apex with multiple layers and/or sections as described below with reference to FIGS. 3-5.

Referring to FIG. 3, a bead-apex assembly 204 may include a bead 210 and an apex 212, and the apex 212 may include a plurality of layers 220, 222, 224. The apex 212 is depicted with three (3) layers, but more or fewer layers may be included. For example, the apex 212 may include five (5) layers, ten (10) layers, twenty (20) layers, fifty (50) layers, or more. A first layer 220 may be attached to, and may be adjacent to, the outer diameter surface 214 of the bead 210, as shown. The first layer 220 may directly contact the bead 210, but this is not required (e.g., a separate component, such as a bead liner, may be included and located at least partially between the first layer 220 and the bead 210). A second layer 222 may be located radially outward of the first layer 220, and a third layer 224 may be located radially outward of the second layer 222. It is contemplated that a liner or other component may be located between the layers, but such a liner or other component is generally optional.

To provide a suitable transition between the bead 210 and the side walls of a ply surrounding the bead-apex assembly 204, each respective layer 220, 222, 224 may decrease in width. For example, a width of the first layer 220 may be greater than a width of the second layer 222, and the width of the second layer 222 may be greater than a width of the third layer 224. In combination, the layers 220, 222, 224 may form the apex 212 with an approximately-triangular profile.

When forming the bead-apex assembly 204, each layer may be applied to the bead 210 alone. For example, the first layer 220 may be wrapped around the outer diameter surface 214 of the bead 210 and secured to the bead 210 in a first pass and prior to deploying the other layers. The tension of the first layer 220 may be controlled during the wrapping and/or the securing process. Then, separately, the second layer 222 may be wrapped in a second pass and secured to an outer diameter surface of the first layer 220. The second layer 222, which may be a strip of extruded material, may have a length that is greater than a length of the first layer 220 to account for the increased circumference of the apex 212 at the second layer 222 with respect to at the first layer 220. Similarly, the third layer 224, which may have a length greater than the length of the second layer 222, may be wrapped in a third pass and secured to an outer diameter of the second layer 222 (at a controlled tension if desired).

In some embodiments, two or more of the layers 220, 222, 224 may be formed by a single continuous strip of material, where the single continuous strip of material is wrapped around the bead 210 in multiple passes such that it becomes layered on top of itself. Alternatively or additionally, two or more of the layers 220, 222, 224 may be distinct and separate strips. The layers may be secured to each other through the use of any suitable means for securement. For example, the layers may be at least partially melted during a heating process such that the material forming the layers becomes at least partially continuous and/or otherwise adheres the layers together. Additionally or alternatively, an adhesive may be placed between the layers. It is contemplated that the layers may be secured via friction and/or configured (e.g., shaped) such that they have elements that interlock. Advantageously, the layered apex 212 of FIG. 3 may have a relatively consistent tension throughout its profile when compared to an apex formed of a single extruded strip (such as the apex of FIG. 2). The apex 212 may therefore be relatively resistant to warping, stretching in an undesirable manner, cracking, breaking, etc. The uniformity of the apex 212 may provide for a bead-apex assembly 204 that is relatively uniform and has a high degree of weight balance both during post-manufacturing testing and when in the hands of the consumer.

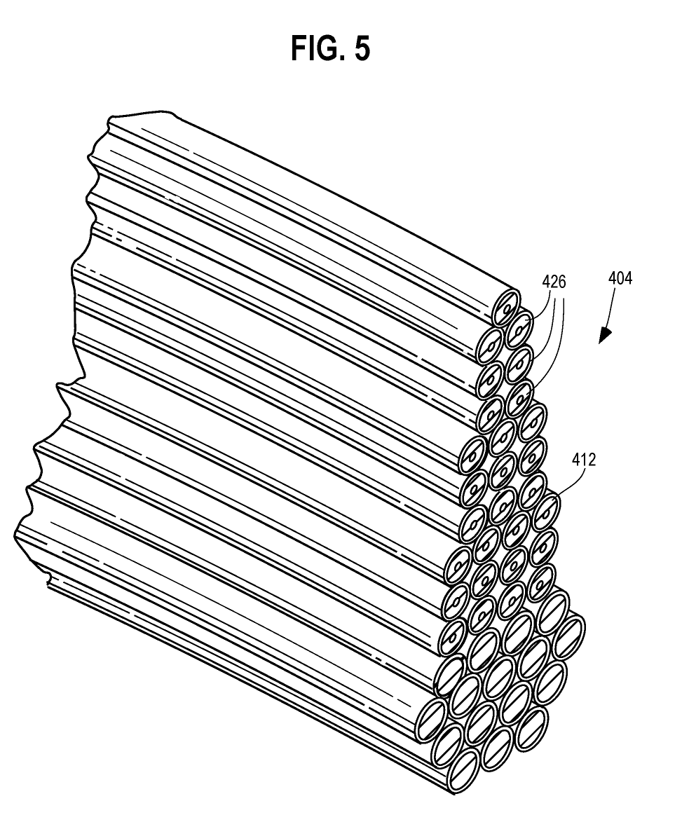

Referring to FIG. 4, an apex 312 may be formed by a plurality of apex sections 326, where one or more of the apex sections 326 have a width that is less than a corresponding width of the apex 312. The apex sections 326 may be arranged to form a plurality of layers 320, 322, 324 of the apex 312, as shown, but it is also contemplated that distinct layers may not be discernable. In the depicted non-limiting example, three of the apex sections 326 are arranged to form a first layer 320 (where each of the apex sections 326 of the first layer 320 may be adjacent to the outer diameter surface 314 of the bead 310), two apex sections 326 are arranged to form a second layer 322 (where the apex sections 326 of the second layer are separated from the outer diameter surface 314 of the bead 310 by the first layer 320), and a single apex section 326 forms a third layer 324. Accordingly, starting at the first layer 320 and moving radially outward, each successive layer may include a decreasing number of apex sections 326, which may advantageously provide an apex 312 with an approximately-triangular cross section. In some embodiments (such as the embodiment of FIG. 5 described in detail below), two or more layers may be formed with the same number of apex sections 326 and/or a layer may have more apex sections 326 than a layer located further radially inward. In exemplary embodiments, an innermost layer of an apex may include from about two (2) apex sections to about fifty (50) apex sections, such as from about four (4) apex sections to about (10) apex sections. The outermost layer may include from about one (1) apex section to about five (5) apex sections, for example.

The cross-sectional shape of the apex sections 326 may preferably be circular for simplicity of manufacturing, but they are not limited to that shape. In some embodiments, one or more of the apex sections 326 may have an ovular, rectangular, hexagonal, or any other suitable cross-sectional shape. Further, the cross-sectional shape of the apex sections 326 may vary within a single apex 312. For example, it is contemplated that the first layer 320 may include one or more apex sections 326 with a cross-sectional shape suitable for providing a relatively large contact surface with the outer diameter of a bead 310 (e.g., an approximately-rectangular cross-sectional shape, which may be suitable for providing a relatively large contact surface when the outer diameter surface of the bead 310 is flat), while outer layers 322, 324 may have apex sections 326 of another shape (e.g., a circular cross-sectional shape, which may be the easiest cross-sectional shape to manufacture).

Similarly, the size of the apex sections 326 may vary. For example, the first layer 320 may include apex sections 326 with relatively large cross-sectional dimensions (e.g., diameters), while the second layer 322 and/or the third layer 324 may include apex sections 326 with relatively small cross-sectional dimensions. Advantageously, an embodiment incorporating different sizes of apex sections 326 may form an apex 312 with a decreasing thickness as it extends radially outward without necessarily varying the number of apex sections 326 per layer (although variation in the number of apex sections 326 may still occur). Further, the length (e.g., circumference) of the apex sections 326 may vary. In exemplary embodiments, the length of an outermost apex section 326 is longer than a length of an innermost apex section 326 to account for the respective difference in circumference.

In some embodiments, it may be advantageous for the apex 312 to have varying properties along its profile. For example, it may be advantageous for the apex to have a relatively rigid inner portion at or near the first layer 320, and a relatively compliant outer portion near at least one of the outer layers 322, 324. This feature may be accomplished by varying the number, size, shape, and/or tension of the apex sections 326 within the apex 312. Further, the material properties of the apex sections 326 may vary. For example, at least one of the apex sections 326 of the first layer 320 may include a first material that has a first degree of a property (e.g., a first rigidity), at least one apex section 326 of the second layer 322 may include a second material with a second degree of a property (e.g., a second rigidity), and the third layer 324 may include at least one apex section 326 with a third degree of the property (e.g., a third rigidity). For example, the first, second, and third materials may include different rubber compositions that vary in rigidity.

As described above, a single and continuous extruded strip may form one or more (and potentially all) of the apex sections 326. The single and continuous strip may be wrapped around a corresponding bead multiple times (i.e., multiple passes) to form the multiple apex sections 326. However, it may be advantageous to use multiple strips or other elongated bodies, particularly when the properties of the apex sections 326 are not constant throughout the entirety of the apex 312. When multiple strips or elongated bodies are used, they may be applied to the apex 312 simultaneously or individually. In one embodiment, a first strip is applied to the apex 312 in a first pass to form at least a portion of the first layer 320. Afterwards, the first strip may be cut at its trailing end, and the trailing end may be optionally secured within the first layer 320. The second strip may then be wrapped during a second pass along the outer diameter of the first layer 320, thereby forming the second layer 322. Similarly, a third strip may form the third layer 324. Any number of distinct strips may be used.

As shown in FIG. 4, at least one of the apex sections 326 may include a core 328 and a sheath 330. The core 328 and the sheath 330 may be formed of different materials and may have different characteristics. For example, the core 328 may include a relatively strong, durable, and inelastic material, while the sheath 330 may include a material that is relatively soft and compliant. In one embodiment, the core 328 may be formed of a nylon and the sheath may be formed of a rubber. Advantageously, the core 328 may provide the apex 312 with suitable strength, durability, rigidity, and/or stability for use in a particular tire while still providing a suitable transition from the bead 310 due to the presence of the soft material of the sheath 330. Adequate strength, durability, rigidity, stability, and the like may be achieved in other (or additional) ways. For example, the apex 312 may have one or more apex sections 326 located near the center of the profile of the apex 312 that are formed substantially of a metal or other material suitable for providing one or more of these characteristics.

Like the apex 312, the bead 310 may be formed of multiple sections. A plurality of bead sections 332 may be wrapped around a bead former to form the bead 310, for example on a SWS-6000 Bead Winding System or a SWS-4000T Bead Winding System, each of which are manufactured by Bartell Machinery Systems, L.L.C. Each of the bead sections 332 may have a core 334 formed of a relatively rigid, strong, and durable material, and an optional outer sheath 336 formed of a relatively compliant material. The bead sections 332 may be pre-cast into a desired diameter and then wrapped a pre-selected number of times around a fixed diameter former. In some embodiments, the bead sections 332 are held together in a ribbon of insulated rubber compound, but other means for holding the bead sections 332 together may additionally or alternatively be used.

As shown in FIG. 5, a bead-apex assembly 404 may include an apex 412 with more than three (3) layers. As shown, the apex 312 includes ten (10) layers, and it is contemplated that an exemplary apex in accordance with the present disclosure could include from about two (2) layers to about fifty (50) layers, such as from about four (4) layers to about ten (10) layers. Further, an exemplary apex 412 may include from about three (3) apex sections 426 to about two-hundred (200) apex sections 426, such as between about nine (9) apex sections 426 to about fifty (50) apex sections 426 (including twenty-eight (28) apex sections 426 as shown). While the apex sections 426 are generally described as arranged in a plurality of layers, distinct layers may not be discernable. The apex sections 426 may be arranged to form an apex 426 with any suitable shape for use in a tire.

While various embodiments of the invention have been described, the invention is not to be restricted except in light of the attached claims and their equivalents. Moreover, the advantages described herein are not necessarily the only advantages of the invention and it is not necessarily expected that every embodiment of the invention will achieve all of the advantages described.

We claim:

1. A bead-apex assembly for a vehicle tire, the bead-apex assembly comprising:
a bead with an outer diameter surface; and
an apex with a first layer and a second layer, the first layer having an inner diameter located adjacent to the outer diameter surface of the bead, and the second layer having an inner diameter located adjacent to an outer diameter of the first layer.

2. The bead-apex assembly of claim 1, wherein the first layer includes a first apex section and a second apex section, wherein each of the first apex section and the second apex section are adjacent to the outer diameter surface of the bead.

3. The bead-apex assembly of claim 2, wherein the first apex section includes a core formed of a first material and a sheath formed of a second material.

4. The bead-apex assembly of claim 2, wherein the first apex section and the second apex section are formed by a continuous strip.

5. The bead-apex assembly of claim 1, wherein the first layer is at least partially formed of a first strip, wherein the second layer is at least partially formed of a second strip, and wherein the first strip is separate from the second strip.

6. The bead-apex assembly of claim 1, wherein the first layer has a width larger than a width of the second layer.

7. The bead-apex assembly of claim 1, wherein the first layer has a first length, wherein the second layer has a second length, and wherein the second length is greater than the first length.

8. The bead-apex assembly of claim 1, wherein the first layer includes a first rigidity, wherein the second layer includes a second rigidity, and wherein the first rigidity is greater than the second rigidity.

9. A bead-apex assembly for a vehicle tire, the bead-apex assembly comprising:
a bead with an outer diameter surface; and
an apex with a first apex section and a second apex section,
wherein the first apex section is attached to the outer diameter surface of the bead, and
wherein the first apex section is placed at least partially between the outer diameter surface of the bead and the second apex section.

10. The bead-apex assembly of claim 9, further comprising a third apex section, wherein the third apex section is located adjacent to the first apex section, and wherein the third apex section is located adjacent the outer diameter surface of the bead.

11. The bead-apex assembly of claim 10, wherein the first apex section and the third apex section form at least a portion of a first layer, and wherein the second apex section forms at least a portion of a second layer, the first layer being located at least partially between the second layer and the outer diameter surface of the bead.

12. The bead-apex assembly of claim 10, wherein the first apex section and the third apex section are formed by a continuous strip.

13. The bead-apex assembly of claim 12, wherein the first apex section is formed when wrapped around the outer diameter surface of the bead during a first pass, and wherein the third apex section is formed when wrapped around the outer diameter surface of the bead during a second pass.

14. The bead-apex assembly of claim 9, wherein the first apex section and the second apex section each include a core formed of a first material and a sheath formed of a second material.

15. The bead-apex assembly of claim 9, wherein the first apex section includes a first material, wherein the second apex section includes a second material, and wherein the first material is different than the second material.

16. The bead-apex assembly of claim 9, wherein the first apex section and the second apex section each have a circular cross-sectional profile.

17. The bead-apex assembly of claim 16, wherein the first apex section has a first length, wherein the second apex section has a second length, and wherein the first length is greater than the second length.

18. A method for forming a bead-apex assembly, the method comprising:
wrapping a first apex section around an outer diameter surface of a bead; and
wrapping a second apex section around the outer diameter surface of the bead after the step of wrapping the first apex section around the outer diameter surface of the bead,
wherein the first apex section and the second apex section are formed by a continuous strip.

19. The method of claim 18, further comprising wrapping a third apex section around an outer diameter surface of the first apex section such that the first apex section is located at least partially between the outer diameter surface of the bead and the third apex section.

20. The method of claim 18, wherein the first and second apex sections at least partially form first layer adjacent to the outer diameter surface of the bead, the method further comprises forming a second layer located radially outward of the second layer.
